(19) United States
(12) Patent Application Publication
(10) Pub. No.: US 2014/0051486 A1
(43) Pub. Date: Feb. 20, 2014

(54) Removable Handle for Mobile Phone

(71) Applicant: Pedro Antonio Martinez Ramirez, Austin, TX (US)

(72) Inventor: Pedro Antonio Martinez Ramirez, Austin, TX (US)

(21) Appl. No.: 13/589,165

(22) Filed: Aug. 19, 2012

(51) Int. Cl. H04M 1/04

(52) U.S. Cl. CPC H04M 1/04
USPC 455/575.1

(57) ABSTRACT

Two suction cups screwed into each end of a D-shaped handle. Each end of the D-shaped handle has a #8-32 internal thread. Each of the suction cups has a head and a neck and a stud screwed into the neck. Each of the studs has a #8-32 external thread that allows each of the suction cups to be screwed into each of end of the D-shaped handle. The removable handle for mobile attaches to the back of a mobile phone to provide additional ways to hold such phone and minimize the risk of damage to the phone due to drops.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

With the increase use of mobile phones in our society, the need to provide additional ways of handling phones is becoming a need for users of such devices. Handles have been used for many years to enhance the control of many materials or objects. Typical handles are shown, for example, in the following United States of America patents:
D647,085 Chung et al.
D584,299 Cruz
U.S. Pat. No. 2,310,252 Moomaw

Though such handles have achieved commercial success and popularity, the need to improve on this is needed. As more and more people use mobile phones to perform various tasks the need to provide better way to handle mobile phones is increasing.

The most commonly way to handle a mobile phone is to grab it with the hand, where the finger tips provide enough pressure to maintain the phone in the desired position, this exposes the phone to be dropped and damaged. The removable handle for mobile phone provides additional ways to hold the phone in order to minimize such risk. Also provides a way for persons with hand conditions, like rheumatoid arthritis, where they cannot extend their hand to hold the phone, with the ability to hold these types of phones.

### BRIEF SUMMARY OF THE INVENTION

The removable handle for mobile phone consists of a D-shaped handle with suction cups screwed at each end of the handle. The handle is attached to the phone by pressing the suction cups to the back of the phone. The vacuum created by the suction cups enables the handle to remain attached to the phone, thus providing additional ways to hold the phone.

### BRIEF DESCRIPTION OF THE SEVERAL VIEWS OF THE DRAWING

In the drawings, that form part of this specification,

FIG. 1 is the right side view of the removable handle;

FIG. 2 is the left view of the removable handle;

FIG. 3 is the front view of the removable handle;

FIG. 4 is the back view of the removable handle;

FIG. 5 shows the removable handle attached to the back of a mobile device;

FIG. 6 shows how the suction cup, with a #8-32 stud, screws into one end of the D-shaped handle.

FIG. 7 shows the suction cup, with a #8-32 stud, screwed to one end of the D-shaped dandle.

FIG. 8 shows the removable handle serving as a stand for the phone.

### DETAILED DESCRIPTION OF THE INVENTION

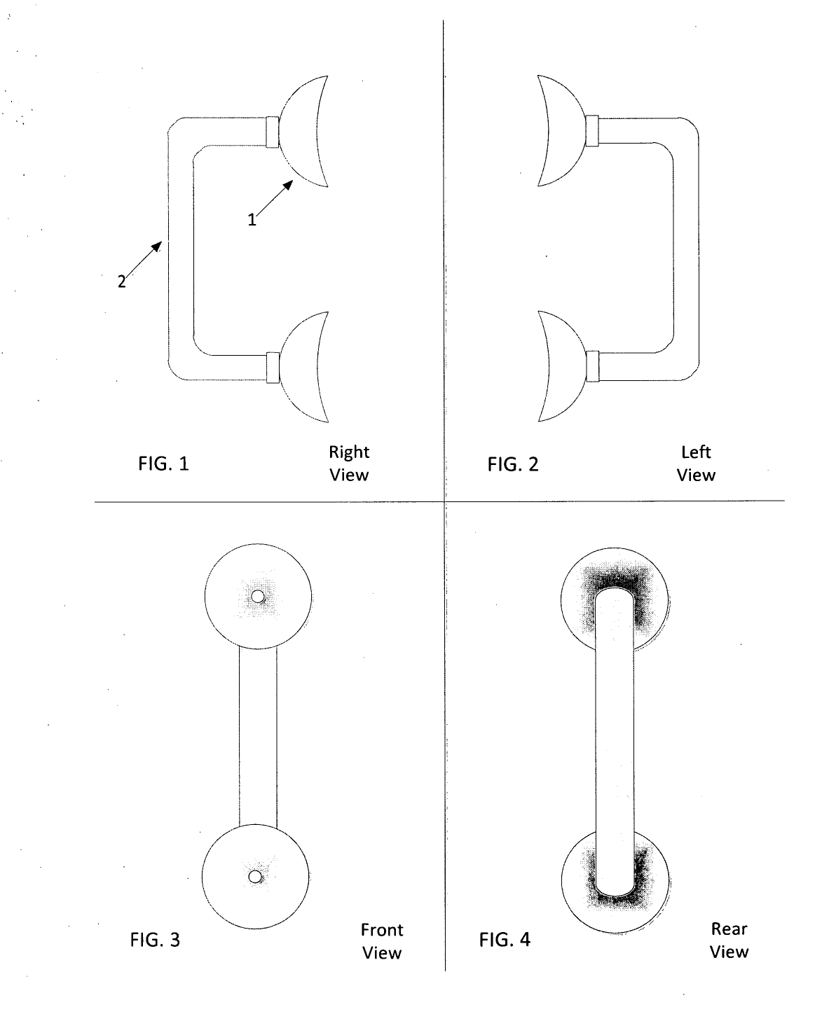

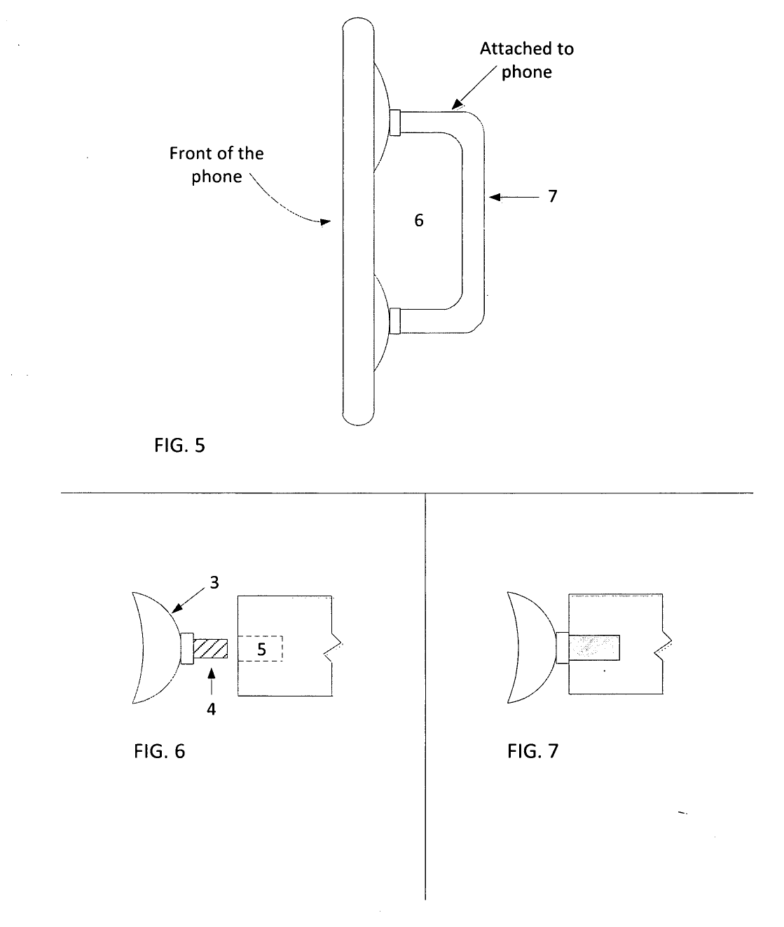

The invention illustrated, removable handle for mobile phone, comprises of two suction cups 1 and a D-shaped handle 2 as seen in FIG. 1.

Each suction cup has a stud attached to it 3 and each stud has a #8-32 external thread 4; each end of the D-shaped handle has a #8-32 internal thread 5, as seen in FIG. 6.

Each suction cup is attached to the D-shaped handle by screwing the external thread of the stud, attached to the suction cup, to the internal thread of one end of the handle as seen in FIG. 7.

The removable handle for mobile phone is attached to the mobile phone by pressing the handle to the back of the phone, the vacuum created by each of the suction cups allows the handle to remain attached to the phone.

To de-attach the removable handle for mobile phone, from the back of the phone, lift on the edge of each of the suction cups to fill the vacuum created with air, thus, allowing the suction cups to de-attach from the mobile phone.

When attached to the phone, the removable handle for mobile phones, provides additional ways to hold the phone.

The first one is to slide the index, middle and ring fingers of the hand through the space that is created between the handle and the back of the phone 6, the handle increases the support of the phone by adding support points. When the phone is in a vertical position, the upper part of the handle rests in the side of the pointer finger to provide extra support. When the phone is in horizontal position, the middle part of the handle 7, rests on the back of the above mentioned fingers thus providing additional support.

The second way is to hold the handle, of the removable handle for mobile phones, along the middle section of the handle 7. The support is provided by the handle itself. This particular way of holding the phone is the one proposed to be used by person with hand problems that cannot extend the hand to hold the phone in the traditional way.

The third way is to slide the index, middle and ring fingers of the hand through the space that is created between the handle and the back of the phone 6, where the back of the hand rests on the back of the phone and the palm of the hand faces the middle section of the handle 7. This particular way of holding the phone frees most of the hand to perform additional tasks (i.e. holding a cup or picking up an object).

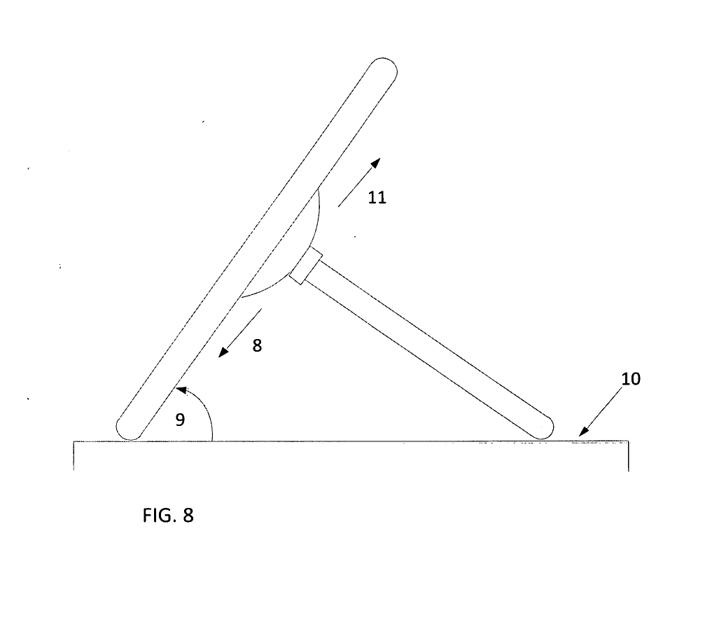

When attached to the phone, the removable handle for mobile phones, also serves as a stand for the phone as shown in FIG. 8.

When used as a stand, the handle provides different levels of inclination depending on the position where the handle is placed. The further to the bottom 8 that the handle is placed, the greater the angle 9 of the phone with respect to the plain 10, will be.

The further to the top 11 that the handle is placed, the lesser the angle 9 of the phone with respect to the plain 10, will be. This allows the user to keep eye contact with the screen of the phone from the distance and hands free.

1. A removable handle for mobile phone to provide additional ways to hold a mobile phone, said handle comprising of a D-shaped handle, each end of the said D-shaped handle adapted to receive a suction cup, by having an internal #8-32 thread. Each of the said suction cups, comprising a cup portion, a neck portion and a stud, said stud having external #8-32 thread to attach each of the said suction cups, to each end of the said D-shaped handle, by screwing the external thread of each of the said suction cup studs to the internal thread of each of the said ends of the said D-shaped handle.
